(19) United States
(12) Patent Application Publication
(10) Pub. No.: US 2024/0371364 A1
(43) Pub. Date: Nov. 7, 2024

(54) MIXED REALITY SYSTEM WITH ACOUSTIC EVENT DETECTION, ADAPTIVE ANCHORS FOR OBJECT PLACEMENT, AND IMPROVED LED DESIGN

(71) Applicant: Meta Platforms Technologies, LLC, Menlo Park, CA (US)

(72) Inventors: Mohammad Keshavarzi, Zurich (CH); Biqiao Zhang, Redmond, WA (US); Yun Wang, Mountain View, CA (US); Zhaojun Yang, Bellevue, WA (US); Yangyang Shi, Bellevue, WA (US); Varun Kumar Nagaraja, San Jose, CA (US); Gael Le Lan, Rennes (FR); Xin Lei, Bellevue, WA (US); Sangeeta Srivastava, Bothell, WA (US); Ming Sun, Seattle, WA (US); Jason Dong Uk Kim, Lucas, TX (US); Li Wan, New York, NY (US); Yuguan Li, Winchester, MA (US); Qian Zhao, San Jose, CA (US); Liang Zhang, Singapore (SG); Peter Roberts, Abingdon (GB)

(21) Appl. No.: 18/642,606

(22) Filed: Apr. 22, 2024

Related U.S. Application Data
(60) Provisional application No. 63/464,295, filed on May 5, 2023.

(51) Int. Cl. G10L 15/08

(52) U.S. Cl. CPC G10L 15/08; G10L 2015/088

(57) ABSTRACT

A system uses a machine learning model trained using multitask learning for processing audio signals of different types. The system may be used in a device such as a headset, smart glasses, or a smart watch, and may be used to make predictions based on different types of audio signals, for example, for classifying acoustic events based on audio signal or for keyword spotting to detect wake words. The use of a single machine learning model for analyzing different types of audio signals improves storage efficiency as well as energy efficiency of devices compared to systems that use a different machine learning model for processing each type of audio signal.

### CROSS-REFERENCE TO RELATED APPLICATIONS

This application claims of the benefit of U.S. Provisional Patent Application No. 63/464,295, filed May 5, 2023, which is incorporated by reference.

### FIELD OF THE INVENTION

This disclosure relates generally to augmented and virtual reality environments, and, in particular, to various approaches for providing audio and visual content to a user in such environments.

### BACKGROUND

Devices such as artificial reality headsets, smart glasses, smart watches, and others user machine learning models for making various types of predictions. The machine learning models may be used for object recognition in images, for speech recognition, and so on. For example, a device may respond to a wake word and a machine learning model may be used for recognizing the wake word. These machine learning models may have large number of parameters, for example, several million parameters. Due to physical size limitations, such devices have small computing power and small memory for storing data. As a result, such devices may not be able to store large machine learning models or multiple machine learning models for processing different type of information.

Not knowing the end-users' local scenes is a challenge for mixed reality (MR), virtual reality (VR) and augmented reality (AR) content development. This challenge becomes a bottleneck when aiming to develop and curate spatial experiences for a large number of users. End users hold diverse spatial environments, which differ in dimensions, functions (rooms, workplace, garden, etc.), and available activity spaces. Certain furniture, elements and corresponding functionalities may be available in one space, while absent for others.

There are currently two industry solutions for this problem: (1) ask the user to place the content; and (2) utilize the Scene Model and procedurally generate content in a rule-based approach. In the user placement approach, content developers potentially lose artistic control and creative direction. User placement may not be in line with what the developer envisions and may collide with the experience logic. Such an approach also requires effort from the user to setup the experience. Procedural modeling approaches potentially increase developer control but are often limited to a number of layout scenarios, hence developers may not be able to generalize their experiences to all target spaces. To simplify, they may opt to use minimum semantic requirements for the design of the experiences to maximize their audience, but this can slow down the adoption of object-level semantics for MR applications.

Also disclosed herein is an improved micro-LED structure for use in various applications, including within headsets and other wearable devices suitable for providing MR experiences. In contrast to conventional designs, which typically have both the p and n electrodes on the same side of the LED, or have the p and n electrodes on different sides of the epi layers of the LED, the pattern of the electrodes on the light-emitting side of the LED may be selected to improve light extraction/direction and or improve current injection.

### SUMMARY

A system uses a machine learning model trained using multitask learning for processing audio signals of different types. The system may be used in a device such as a headset, smart glasses, or a smart watch, and may be used to make predictions based on different types of audio signals, for example, for classifying acoustic events based on audio signal or for keyword spotting to detect wake words. The use of a single machine learning model for analyzing different types of audio signals improves storage efficiency as well as energy efficiency of devices compared to systems that use a different machine learning model for processing each type of audio signal.

According to an embodiment, an audio sensor of a device receives an audio stream. The system repeats the following steps to analyze various audio signals identified in the audio stream. The system extracts a candidate signal from the audio stream. The system receives an indication of whether the candidate signal represents an acoustic event or a keyword. The system provides the candidate signal as input to a machine learning model trained to predict an output O1 representing a classification of acoustic events and another output O2 representing a classification of the keyword. If the system receives an indication that the candidate signal represents an acoustic event, the system classifies the candidate signal based on the output O1 to determine a type of the acoustic event and perform an action based on the type of the acoustic event. For example, if the system classifies the acoustic event as a clapping by several people, the system may activate a camera to take a picture. If the system receives an indication that the candidate signal represents a keyword, the system classifies the candidate signal based on the second output, and determines whether to activate one or more components of the headset based on the classification.

Embodiments include methods to perform processes comprising steps described herein. Embodiments include computer program product comprising a non-transitory computer-readable storage medium containing computer program code that comprises instructions that when executed by one or more processors, cause the one or more processors to perform steps of methods described herein. Embodiments include computer systems including one or more computer processors and non-transitory computer-readable storage media containing computer program code that comprises instructions that when executed by the one or more processors, cause the one or more processors to perform steps of methods described herein.

Also disclosed herein is an Adaptive Curation Learner (ACL) that uses dynamically placed adaptive anchors to provide content based on room configurations. In one embodiment, a method of using the ACL includes selecting a plurality of different room configurations. For each room configuration of the plurality of room configurations, the ACL receives a corresponding training location for an adaptive anchor from a user device. The adaptive anchor may be associated with a virtual object. The method also includes training an adaptive curation model that predicts a corresponding location of an adaptive anchor for a given room configuration using the plurality of room configurations and the corresponding training locations.

### BRIEF DESCRIPTION OF THE DRAWINGS

FIG. 1 is a perspective view of a headset implemented as an eyewear device, in accordance with one or more embodiments.

FIG. 2 is a block diagram of an audio system, in accordance with one or more embodiments.

FIG. 3 illustrates the system architecture of the audio signal processing module according to an embodiment.

FIG. 4 illustrates the flow of data through various components of the audio signal processing module, according to an embodiment.

FIG. 5 is a flowchart of a process illustrating use of the machine learning model to process audio signals representing acoustic events or wake words, according to an embodiment.

FIG. 6 is a flowchart of a process illustrating use of the machine learning model to process two different types of audio signals, according to an embodiment.

FIG. 7 illustrates the flow of data through various components of the audio signal processing module for training the machine learning model, according to an embodiment.

FIG. 8 is a flowchart of a process illustrating the training of the machine learning model, in accordance with one or more embodiments.

FIG. 9 is a system that includes a headset, in accordance with one or more embodiments.

FIG. 10 illustrates the interaction between various components for voice enrollment, according to an embodiment.

FIG. 11 illustrates the interaction between various components for voice verification, according to an embodiment.

FIG. 12 illustrates an adaptive anchor, according to various embodiments.

FIG. 13 illustrates how a room configuration may be represented with a scene graph representation, according to an embodiment.

FIG. 14 illustrates a process flow for training a model that uses a scene graph that nay be used to determine placement of adaptive anchors, according to an embodiment.

FIG. 15 illustrates a conventional LED structure, according to one example embodiment.

FIG. 16A illustrates a top view of first example of a micro-LED with light extraction enhancement and light direction improvement structures on a top surface, according to one example embodiment.

FIG. 16B illustrates a cross-sectional view of the first example of a micro-LED with light extraction enhancement and light direction improvement structures on a top surface, according to one example embodiment.

FIG. 17A illustrates a top view of a second example of a micro-LED with current confining structures on a top surface, according to one example embodiment.

FIG. 17B illustrates a cross-sectional view of the second example of a micro-LED with current confining structures on the top surface, according to one example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

A system trains a machine learning model using multitask learning and executes the model to process audio signals of different types. The system may be used in a headset or smart glasses. The same machine learning model is used to make different types of predictions. For example, the machine learning model may be used to predict a type of acoustic event identified based on an input audio signal. The same machine learning model may also be used to classify certain keywords, for example, wake words provided to activate components of the headset.

The machine learning model is trained using a training dataset that includes samples of different types of signals. For example, the training dataset may include a subset of samples that represent acoustic events and another subset that represent keywords. The system adjusts the ratio of the size of the subsets of the different types of signals during training of the machine learning model to improve the performance of the machine learning model. The system achieves performance equivalent to systems that use different machine learning models for each task, for example, a machine learning model trained for acoustic event detection and another a machine learning model trained for keyword spotting.

Use of a single model for performing multiple tasks provides improvement in storage efficiency compared to a system that uses a distinct machine learning model for each type of prediction. The improvement is storage efficiency is achieved as a result of use of fewer parameters in a single machine learning model compared to multiple machine learning models. For example, each machine learning model may include hundreds of thousands of parameters or even several million parameters. As a result, the memory occupied by one machine learning model can be significantly less than the memory occupied by multiple machine learning models.

The machine learning model can be used in devices with limited memory capacity, for example, smart glasses, smart watches, and so on. Furthermore, the use of smaller machine learning models results in energy efficient processing of signals.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

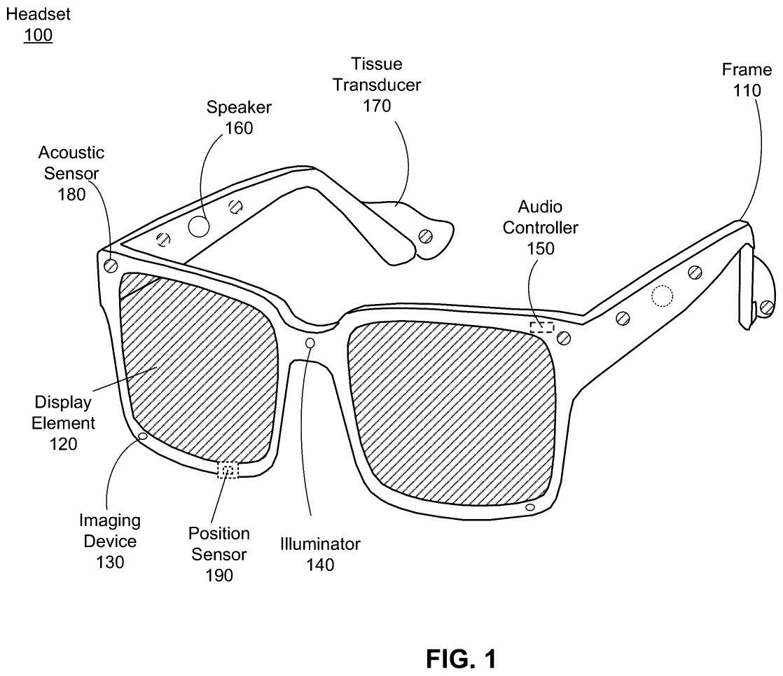

FIG. 1 is a perspective view of a headset 100 implemented as an eyewear device, in accordance with one or more embodiments. In some embodiments, the eyewear device is a near eye display (NED). In general, the headset 100 may be worn on the face of a user such that content (e.g., media content) is presented using a display assembly and/or an audio system. However, the headset 100 may also be used such that media content is presented to a user in a different manner. Examples of media content presented by the headset 100 include one or more images, video, audio, or some combination thereof. The headset 100 includes a frame, and may include, among other components, a display assembly including one or more display elements 120, a depth camera assembly (DCA), an audio system, and a position sensor 190. While FIG. 1 illustrates the components of the headset 100 in example locations on the headset 100, the components may be located elsewhere on the headset 100, on a peripheral device paired with the headset 100, or some combination thereof. Similarly, there may be more or fewer components on the headset 100 than what is shown in FIG. 1.

The frame 110 holds the other components of the headset 100. The frame 110 includes a front part that holds the one or more display elements 120 and end pieces (e.g., temples) to attach to a head of the user. The front part of the frame 110 bridges the top of a nose of the user. The length of the end pieces may be adjustable (e.g., adjustable temple length) to fit different users. The end pieces may also include a portion that curls behind the ear of the user (e.g., temple tip, ear piece).

The one or more display elements 120 provide light to a user wearing the headset 100. As illustrated the headset includes a display element 120 for each eye of a user. In some embodiments, a display element 120 generates image light that is provided to an eyebox of the headset 100. The eyebox is a location in space that an eye of user occupies while wearing the headset 100. For example, a display element 120 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 100. In-coupling and/or outcoupling of light from the one or more waveguides may be done using one or more diffraction gratings. In some embodiments, the waveguide display includes a scanning element (e.g., waveguide, mirror, etc.) that scans light from the light source as it is in-coupled into the one or more waveguides. Note that in some embodiments, one or both of the display elements 120 are opaque and do not transmit light from a local area around the headset 100. The local area is the area surrounding the headset 100. For example, the local area may be a room that a user wearing the headset 100 is inside, or the user wearing the headset 100 may be outside and the local area is an outside area. In this context, the headset 100 generates VR content. Alternatively, in some embodiments, one or both of the display elements 120 are at least partially transparent, such that light from the local area may be combined with light from the one or more display elements to produce AR and/or MR content.

In some embodiments, a display element 120 does not generate image light, and instead is a lens that transmits light from the local area to the eyebox. For example, one or both of the display elements 120 may be a lens without correction (non-prescription) or a prescription lens (e.g., single vision, bifocal and trifocal, or progressive) to help correct for defects in a user's eyesight. In some embodiments, the display element 120 may be polarized and/or tinted to protect the user's eyes from the sun.

In some embodiments, the display element 120 may include an additional optics block (not shown). The optics block may include one or more optical elements (e.g., lens, Fresnel lens, etc.) that direct light from the display element 120 to the eyebox. The optics block may, e.g., correct for aberrations in some or all of the image content, magnify some or all of the image, or some combination thereof.

The DCA determines depth information for a portion of a local area surrounding the headset 100. The DCA includes one or more imaging devices 130 and a DCA controller (not shown in FIG. 1), and may also include an illuminator 140. In some embodiments, the illuminator 140 illuminates a portion of the local area with light. The light may be, e.g., structured light (e.g., dot pattern, bars, etc.) in the infrared (IR), IR flash for time-of-flight, etc. In some embodiments, the one or more imaging devices 130 capture images of the portion of the local area that include the light from the illuminator 140. As illustrated, FIG. 1 shows a single illuminator 140 and two imaging devices 130. In alternate embodiments, there is no illuminator 140 and at least two imaging devices 130.

The DCA controller computes depth information for the portion of the local area using the captured images and one or more depth determination techniques. The depth determination technique may be, e.g., direct time-of-flight (ToF) depth sensing, indirect ToF depth sensing, structured light, passive stereo analysis, active stereo analysis (uses texture added to the scene by light from the illuminator 140), some other technique to determine depth of a scene, or some combination thereof.

The audio system provides audio content. The audio system includes a transducer array, a sensor array, and an audio controller 150. However, in other embodiments, the audio system may include different and/or additional components. Similarly, in some cases, functionality described with reference to the components of the audio system can be distributed among the components in a different manner than is described here. For example, some or all of the functions of the controller may be performed by a remote server.

The transducer array presents sound to user. The transducer array includes a plurality of transducers. A transducer may be a speaker 160 or a tissue transducer 170 (e.g., a bone conduction transducer or a cartilage conduction transducer). Although the speakers 160 are shown exterior to the frame 110, the speakers 160 may be enclosed in the frame 110. In some embodiments, instead of individual speakers for each ear, the headset 100 includes a speaker array comprising multiple speakers integrated into the frame 110 to improve directionality of presented audio content. The tissue transducer 170 couples to the head of the user and directly vibrates tissue (e.g., bone or cartilage) of the user to generate sound. The number and/or locations of transducers may be different from what is shown in FIG. 1.

The sensor array detects sounds within the local area of the headset 100. The sensor array includes a plurality of acoustic sensors 180. An acoustic sensor 180 captures sounds emitted from one or more sound sources in the local area (e.g., a room). Each acoustic sensor is configured to detect sound and convert the detected sound into an electronic format (analog or digital). The acoustic sensors 180 may be acoustic wave sensors, microphones, sound transducers, or similar sensors that are suitable for detecting sounds.

In some embodiments, one or more acoustic sensors 180 may be placed in an ear canal of each ear (e.g., acting as binaural microphones). In some embodiments, the acoustic sensors 180 may be placed on an exterior surface of the headset 100, placed on an interior surface of the headset 100, separate from the headset 100 (e.g., part of some other device), or some combination thereof. The number and/or locations of acoustic sensors 180 may be different from what is shown in FIG. 1. For example, the number of acoustic detection locations may be increased to increase the amount of audio information collected and the sensitivity and/or accuracy of the information. The acoustic detection locations may be oriented such that the microphone is able to detect sounds in a wide range of directions surrounding the user wearing the headset 100.

The audio controller 150 processes information from the sensor array that describes sounds detected by the sensor array. The audio controller 150 may comprise a processor and a computer-readable storage medium. The audio controller 150 may be configured to generate direction of arrival (DOA) estimates, generate acoustic transfer functions (e.g., array transfer functions and/or head-related transfer functions), track the location of sound sources, form beams in the direction of sound sources, classify sound sources, generate sound filters for the speakers 160, or some combination thereof.

The position sensor 190 generates one or more measurement signals in response to motion of the headset 100. The position sensor 190 may be located on a portion of the frame 110 of the headset 100. The position sensor 190 may include an inertial measurement unit (IMU). Examples of position sensor 190 include: one or more accelerometers, one or more gyroscopes, one or more magnetometers, another suitable type of sensor that detects motion, a type of sensor used for error correction of the IMU, or some combination thereof. The position sensor 190 may be located external to the IMU, internal to the IMU, or some combination thereof.

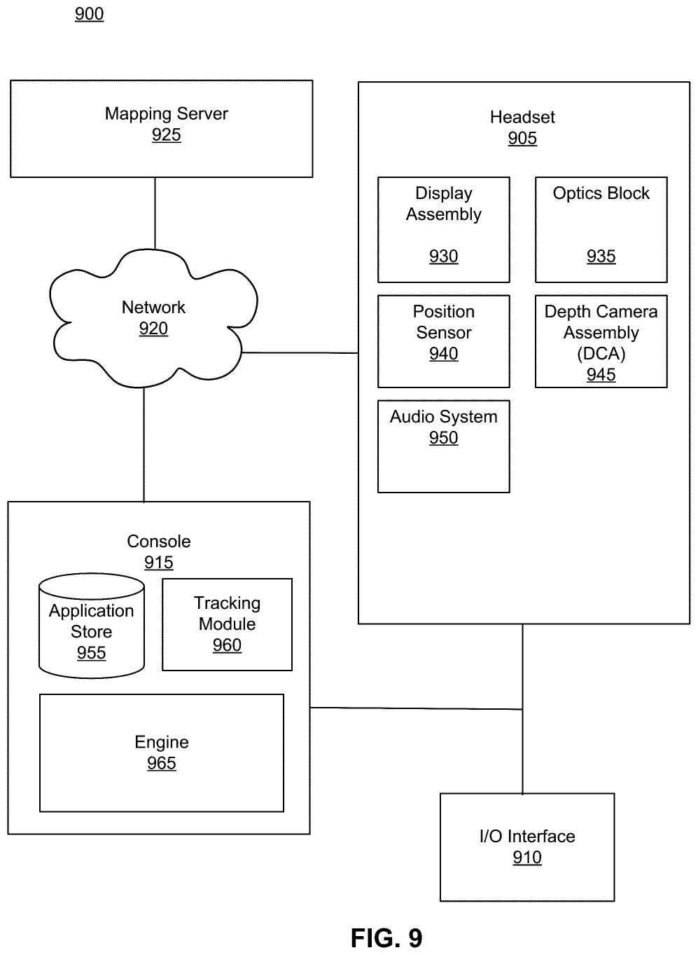

In some embodiments, the headset 100 may provide for simultaneous localization and mapping (SLAM) for a position of the headset 100 and updating of a model of the local area. For example, the headset 100 may include a passive camera assembly (PCA) that generates color image data. The PCA may include one or more RGB cameras that capture images of some or all of the local area. In some embodiments, some or all of the imaging devices 130 of the DCA may also function as the PCA. The images captured by the PCA and the depth information determined by the DCA may be used to determine parameters of the local area, generate a model of the local area, update a model of the local area, or some combination thereof. Furthermore, the position sensor 190 tracks the position (e.g., location and pose) of the headset 100 within the room. Additional details regarding the components of the headset 100 are discussed below in connection with FIG. 9.

The headset 100 may be worn by a user in various contexts, for example, a birthday party, indoor, outdoor, in a crowded area, in natural surroundings, and so on. The headset receives audio signals of different types, for example, audio signals such as wake words that are received from a source close to the headset as well as audio signals such as people laughing, singing, or clapping that is generated from sources that are at least a threshold distance from the headset 100. Furthermore, the signals may have other characteristics, for example, different types of signals may have different durations or sizes. For example, the wake word signal is much smaller in duration compared to a signal representing people laughing or clapping.

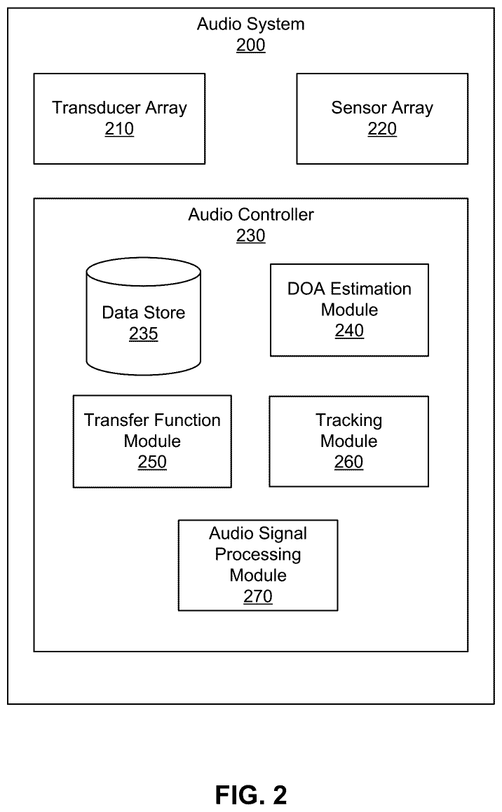

The audio signal is received by the acoustic sensor and provided for processing to the audio system 200 illustrated in FIG. 2 and described in connection with FIG. 2. The headset 100 may receive instructions from the audio system 200 to perform certain actions. For example, the headset 100 may receive instructions to take a photo using a camera of the headset 100 in response to an acoustic event of clapping being detected. The headset 100 may activate one or more components in response to a wake word being detected by the audio system. The details of the audio system 200 as described below.

FIG. 2 is a block diagram of an audio system 200, in accordance with one or more embodiments. The audio system in FIG. 1 may be an embodiment of the audio system 200. The audio system 200 generates one or more acoustic transfer functions for a user. The audio system 200 may then use the one or more acoustic transfer functions to generate audio content for the user. In the embodiment of FIG. 2, the audio system 200 includes a transducer array 210, a sensor array 220, and an audio controller 230. Some embodiments of the audio system 200 have different components than those described here. Similarly, in some cases, functions can be distributed among the components in a different manner than is described here.

The transducer array 210 is configured to present audio content. The transducer array 210 includes a plurality of transducers. A transducer is a device that provides audio content. A transducer may be, e.g., a speaker (e.g., the speaker 160), a tissue transducer (e.g., the tissue transducer 170), some other device that provides audio content, or some combination thereof. A tissue transducer may be configured to function as a bone conduction transducer or a cartilage conduction transducer. The transducer array 210 may present audio content via air conduction (e.g., via one or more speakers), via bone conduction (via one or more bone conduction transducer), via cartilage conduction audio system (via one or more cartilage conduction transducers), or some combination thereof. In some embodiments, the transducer array 210 may include one or more transducers to cover different parts of a frequency range. For example, a piezoelectric transducer may be used to cover a first part of a frequency range and a moving coil transducer may be used to cover a second part of a frequency range.

The transducer array 210 generates audio content in accordance with instructions from the audio controller 230. In some embodiments, the audio content is spatialized. Spatialized audio content is audio content that appears to originate from a particular direction and/or target region (e.g., an object in the local area and/or a virtual object). For example, spatialized audio content can make it appear that sound is originating from a virtual singer across a room from a user of the audio system 200. The transducer array 210 may be coupled to a wearable device (e.g., the headset 100 or the headset 105). In alternate embodiments, the transducer array 210 may be a plurality of speakers that are separate from the wearable device (e.g., coupled to an external console).

The sensor array 220 detects sounds within a local area surrounding the sensor array 220. The sensor array 220 may include a plurality of acoustic sensors that each detect air pressure variations of a sound wave and convert the detected sounds into an electronic format (analog or digital). The plurality of acoustic sensors may be positioned on a headset (e.g., headset 100 and/or the headset 105), on a user (e.g., in an ear canal of the user), on a neckband, or some combination thereof. An acoustic sensor may be, e.g., a microphone, a vibration sensor, an accelerometer, or any combination thereof. In some embodiments, the sensor array 220 is configured to monitor the audio content generated by the transducer array 210 using at least some of the plurality of acoustic sensors. Increasing the number of sensors may improve the accuracy of information (e.g., directionality) describing a sound field produced by the transducer array 210 and/or sound from the local area.

The audio controller 230 controls operation of the audio system 200. In the embodiment of FIG. 2, the audio controller 230 includes a data store 235, a DOA estimation module 240, a transfer function module 250, a tracking module 260, and a signal processing module 270. The audio controller 230 may be located inside a headset, in some embodiments. Some embodiments of the audio controller 230 have different components than those described here. Similarly, functions can be distributed among the components in different manners than described here. For example, some functions of the controller may be performed external to the headset. The user may opt in to allow the audio controller 230 to transmit data captured by the headset to systems external to the headset, and the user may select privacy settings controlling access to any such data.

The data store 235 stores data for use by the audio system 200. Data in the data store 235 may include sounds recorded in the local area of the audio system 200, audio content, head-related transfer functions (HRTFs), transfer functions for one or more sensors, array transfer functions (ATFs) for one or more of the acoustic sensors, sound source locations, virtual model of local area, direction of arrival estimates, sound filters, and other data relevant for use by the audio system 200, or any combination thereof. The data store 235 may store parameters of machine learning models used for signal processing.

The DOA estimation module 240 is configured to localize sound sources in the local area based in part on information from the sensor array 220. Localization is a process of determining where sound sources are located relative to the user of the audio system 200. The DOA estimation module 240 performs a DOA analysis to localize one or more sound sources within the local area. The DOA analysis may include analyzing the intensity, spectra, and/or arrival time of each sound at the sensor array 220 to determine the direction from which the sounds originated. In some cases, the DOA analysis may include any suitable algorithm for analyzing a surrounding acoustic environment in which the audio system 200 is located.

For example, the DOA analysis may be designed to receive input signals from the sensor array 220 and apply digital signal processing algorithms to the input signals to estimate a direction of arrival.

The transfer function module 250 is configured to generate one or more acoustic transfer functions. Generally, a transfer function is a mathematical function giving a corresponding output value for each possible input value. Based on parameters of the detected sounds, the transfer function module 250 generates one or more acoustic transfer functions associated with the audio system. The acoustic transfer functions may be array transfer functions (ATFs), head-related transfer functions (HRTFs), other types of acoustic transfer functions, or some combination thereof. An ATF characterizes how the microphone receives a sound from a point in space.

An ATF includes a number of transfer functions that characterize a relationship between the sound source and the corresponding sound received by the acoustic sensors in the sensor array 220. Accordingly, for a sound source there is a corresponding transfer function for each of the acoustic sensors in the sensor array 220. And collectively the set of transfer functions is referred to as an ATF. Accordingly, for each sound source there is a corresponding ATF. Note that the sound source may be, e.g., someone or something generating sound in the local area, the user, or one or more transducers of the transducer array 210. The ATF for a particular sound source location relative to the sensor array 220 may differ from user to user due to a person's anatomy (e.g., ear shape, shoulders, etc.) that affects the sound as it travels to the person's ears. Accordingly, the ATFs of the sensor array 220 are personalized for each user of the audio system 200.

The tracking module 260 is configured to track locations of one or more sound sources. The tracking module 260 may compare current DOA estimates and compare them with a stored history of previous DOA estimates. In some embodiments, the audio system 200 may recalculate DOA estimates on a periodic schedule, such as once per second, or once per millisecond.

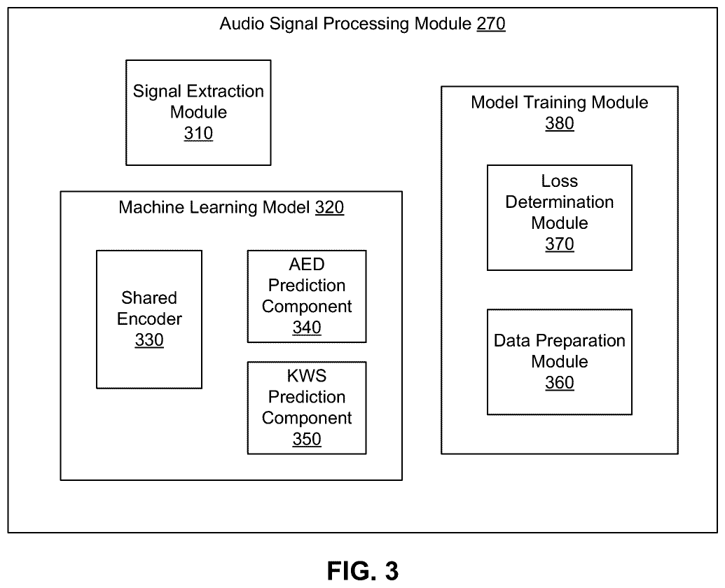

The audio signal processing module 270 performs processing of audio signal received by the audio system 200 using machine learning models. The audio signal processing module 270 makes predictions based on the signal, for example, by detecting and classifying an acoustic event or detecting presence of a wake word. Accordingly, the system uses the machine learning model to perform different types of tasks, for example, tasks representing acoustic event detection and tasks representing keyword spotting. Details of the audio signal processing module 270 are provided in FIG. 3.

FIG. 3 illustrates the system architecture of the audio signal processing module according to an embodiment. The audio signal processing module 270 comprises a signal extraction module 310, a machine learning model 320, and a model training module 380. Other embodiments may include more or fewer components.

The signal extraction module 310 receives an audio stream and extracts a signal representing an acoustic event or a signal representing keywords such as wake words. A signal representing an acoustic event may also be referred to herein as an AED (acoustic event detection) signal. A signal representing a keyword may also be referred to as a KWS (keyword spotter) signal from the audio stream if available. According to an embodiment, the signal extraction module 310 generates a frequency representation of an input audio signal, for example, by applying a Fast Fourier Transform (FFT) to the input signal to transform the input signal from time domain to a frequency domain. For example, the signal extraction module 310 may generate a Mel spectrogram based on the input audio signal.

The machine learning model 320 includes a shared encoder component 330 (also referred to as the shared encoder), an AED prediction component 340 and a KWS prediction component 350. Accordingly, a set of parameters corresponding to the shared encoder are used for predicting acoustic events as well as for keyword detection. The set of parameters of the AED prediction component 340 are used for prediction of the acoustic events, for example, to perform multi-label classification to determine a likelihood of occurrence of each of a plurality of acoustic events based on an input signal. The set of parameters of the KWS prediction component 350 are used for keyword spotting, for example, for performing binary classification to determine whether an input signal represents a keyword such as a wake word. According to an embodiment, each of the components of the machine learning model represents a multi-layered neural network such as a multi-layered convolutional neural network. The AED signals and the KWS signals extracted from the audio stream are provided as input to the machine learning model 320. The machine learning model 320 is trained to predict one or more AED scores and a KWS score.

The model training module 380 trains the machine learning model 320 using training data generated by the data preparation module 360. The model training module 380 includes a data preparation module 360 and a loss determination module 370. The data preparation module 360 prepares data for use as training dataset for the machine learning model 320. The loss determination module 370 determines a loss value based on the scores output by the machine learning model 320 during training.

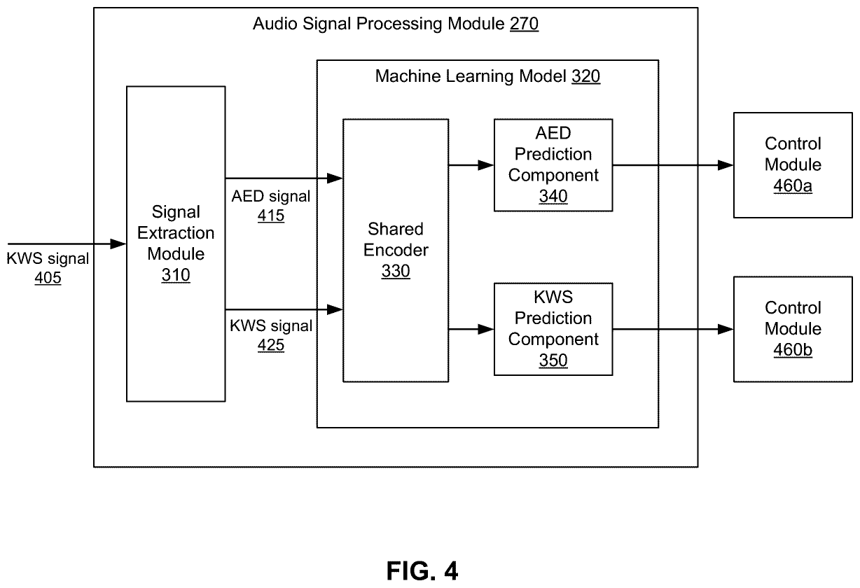

FIG. 4 illustrates the flow of data through various components of the audio signal processing module, according to an embodiment. The signal extraction module 310 receives an audio stream 405 and extracts the AED signal 415 and/or the KWS signal 425 is available in the audio stream. According to an embodiment, the signal extraction module 310 processes the audio signal to transform the audio signal to a different representation that is processed by the neural network. According to an embodiment, the signal extraction module 310 generates a frequency representation of an input audio signal, for example, by applying a Fast Fourier Transform (FFT) to the input signal to transform the input signal from time domain to a frequency domain. For example, the signal extraction module 310 may generate a Mel spectrogram based on the input audio signal. The Mel spectrogram converts the frequencies of the input audio signal to a Mel scale.

The AED signal 415 or the KWS signal 425 is provided as input to the shared encoder 330. The shared encoder 330 generates an encoded representation of the audio signal. If the machine learning model 320 receives as input, an AED signal 415, the encoded representation of the signal is further processed by the AED component 340 to generate an AED score. The AED score is used to determine the type of acoustic event represented by the AED signal. The audio signal processing module 270 may send a signal to a control module 460a to perform an action based on the type of acoustic event. For example, is the acoustic event detected is clapping by several people, the control module 460a may capture a picture using a camera of the headset 100. If the acoustic event is the sound of a vacuum cleaner, the control module 460a may reduce the background noise of the input signal by activating noise cancellation. If the machine learning model 320 receives as input, a KWS signal 425, the encoded representation of the signal is further processed by the AED component 340 to generate a KWS score. The KWS score is used to determine whether a wake word is present in the signal identified as the KWS signal 425. If the audio signal processing module 270 determines that the KWS signal 425 is a wake word, the audio signal processing module 270 sends a signal to a control module 460b. According to an embodiment, the control module 460b is an assistant that activates various components of the headset in response to receiving a wake word.

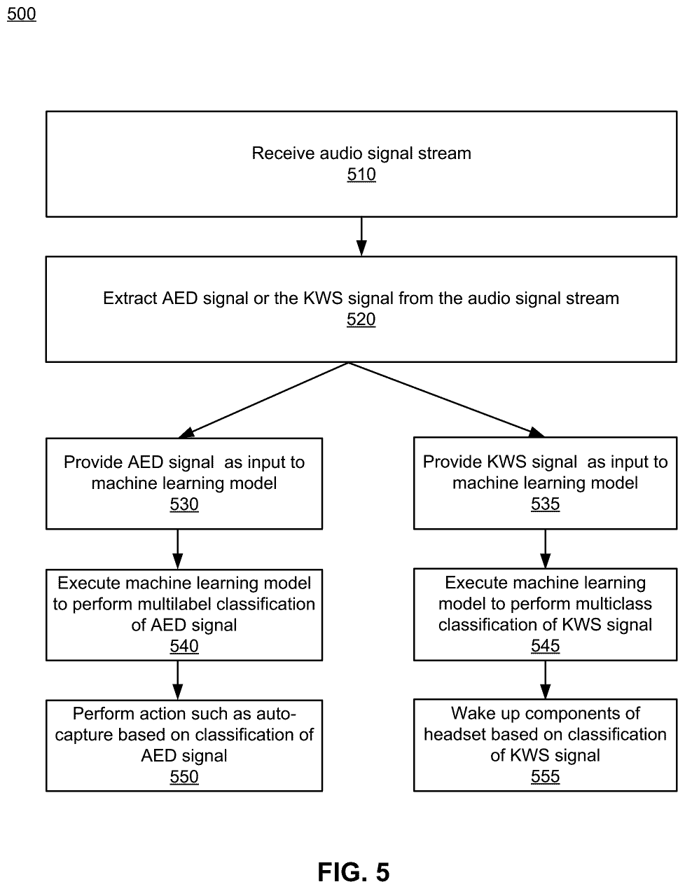

FIG. 5 is a flowchart of a process illustrating use of the machine learning model to process audio signals representing acoustic events or wake words, according to an embodiment. The process shown in FIG. 5 may be performed by components of an audio system (e.g., audio system 200). Other entities may perform some or all of the steps in FIG. 5 in other embodiments. Embodiments may include different and/or additional steps, or perform the steps in different orders.

The audio system receives 510 an audio signal stream. The signal extraction module 310 extracts 520 a candidate signal from the audio stream. The candidate signal may be an AED signal 415 or a KWS signal 425. The subsequent steps are executed depending on the type of audio signal detected. For example, if the audio signal is determined to be an AED signal, the steps 530, 540, and 550 are executed, whereas if the audio signal is determined to be a KWS signal, the steps 535, 545, and 555 are executed.

If an AED signal 415 is detected in the audio signal stream, the signal extraction module 310 provides 530 the AED signal 415 to the machine learning model 320. The machine learning model 320 is executed 540 to perform a multi-label classification of the AED signal. The audio system 200 determines based on the multi-label classification, the type of acoustic event represented by the AED signal 415. The control module 460a performs 550 an action based on the type of acoustic event. For example, if the acoustic event represents clapping by a group of people, the action performed 550 may be taking a picture using a camera of the headset 100. If the acoustic event represents a sound of a vacuum cleaner, a leaf blower, or any other loud machinery or other equipment, the action performed 550 may be reducing the volume of the audio signal being played by the speakers of the headset 100. Depending on the acoustic event the control module 460a may send signals to equipment in a smart home to take a relevant action, for example, turning certain equipment within a home, on or off depending on the acoustic event.

If a KWS signal 425 is detected in the audio signal stream, the signal extraction module 310 provides 535 the KWS signal 425 to the machine learning model 320. The machine learning model 320 is executed 545 to perform a multi-class classification of the AED signal. The audio system 200 determines based on the multi-class classification, whether the KWS signal 425 represents a wake word. The control module 460b activates 555 certain components of the headset 100 if the KWS signal 425 represents a wake word.

The process disclosed in FIG. 5 can be applied to any types of two or more audio signals that the machine learning model is trained to recognize and is not limited to AED signal and KWS signals. The different types of audio signals recognized may have different sources that may be located at different distances from each other. Furthermore, the different audio signals may be of differ lengths, for example, one type of audio signal may be much longer than the other type of audio signal. The two types of audio signals may have different characteristics and features, for example, in terms of volume, frequencies of the signal and so on.

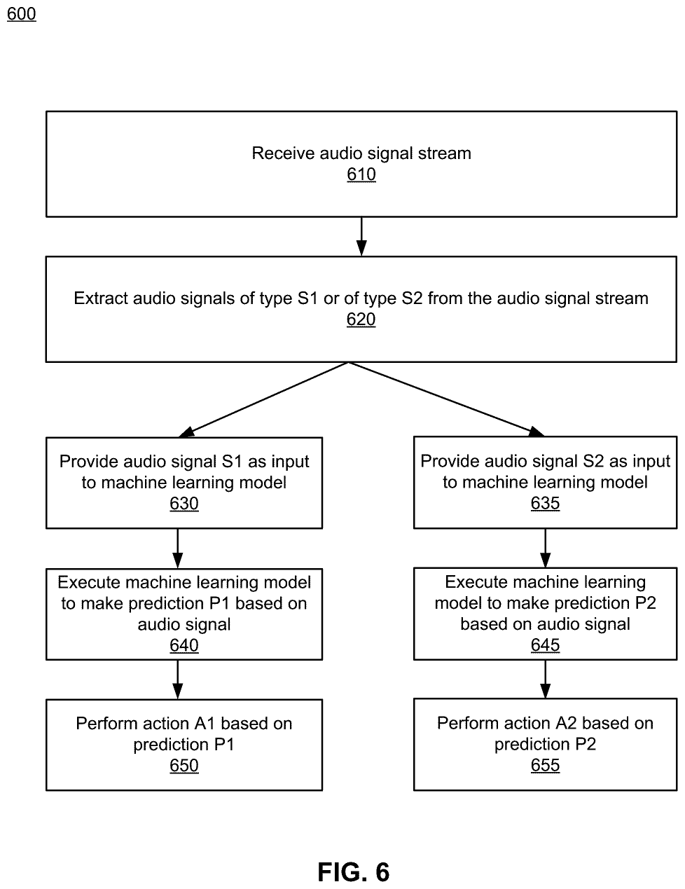

FIG. 6 is a flowchart of a process illustrating use of the machine learning model to process two different types of audio signals, according to an embodiment. The process shown in FIG. 6 may be performed by components of an audio system (e.g., audio system 200). Other entities may perform some or all of the steps in FIG. 6 in other embodiments. Embodiments may include different and/or additional steps, or perform the steps in different orders.

The audio system receives 610 an audio signal stream. The signal extraction module 310 extracts 620 an audio signal of type S1 or an audio signal of type S2 from the audio signal stream. The subsequent steps are executed depending on the type of audio signal detected. For example, if the audio signal is determined to be an audio signal of type S1, the steps 630, 640, and 650 are executed, whereas if the audio signal is determined to be an audio signal of type S2, the steps 635, 645, and 555 are executed.

If an audio signal of type S1 is detected in the audio signal stream, the signal extraction module 310 provides 630 the audio signal to the machine learning model 320. The machine learning model 320 is executed 640 to make a prediction P1 based on the audio signal. The control module 460a performs 650 an action A1 based on the prediction P1.

If an audio signal of type S2 is detected in the audio signal stream, the signal extraction module 310 provides 635 the audio signal to the machine learning model 320. The machine learning model 320 is executed 640 to make a prediction P2 based on the audio signal. The control module 460b performs 650 an action A2 based on the prediction P2.

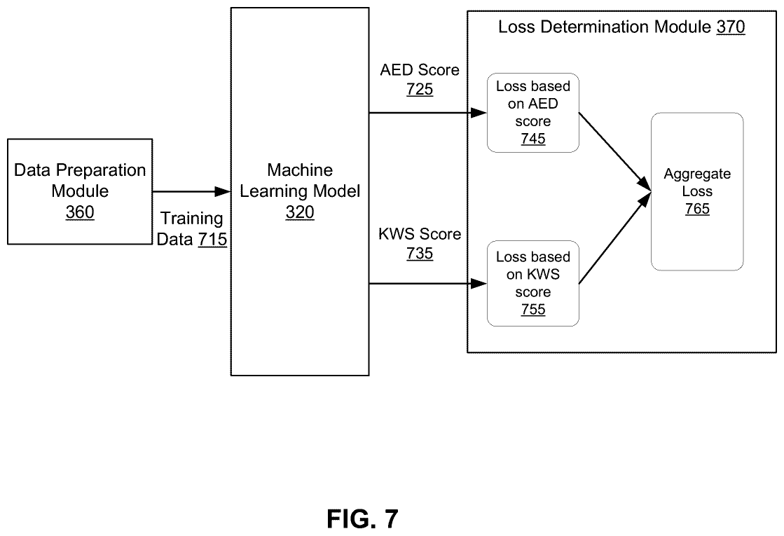

FIG. 7 illustrates the flow of data through various components of the audio signal processing module for training the machine learning model, according to an embodiment. The data preparation module 360 generates datasets for training the machine learning model 320. The datasets generated by the data preparation module 360 are used as batches for training the machine learning model. According to an embodiment, the data preparation module 360 combines data that includes audio signals of different types for training the machine learning model 320. Accordingly, if the machine learning model 320 is configured to make predictions for two different types of signals S1 and S2, the data preparation module 360 generates a dataset that includes some samples of signals of type S1 and some samples of signals of type S2. For example, if the machine learning model 320 is configured to output scores for classifying AED signals as well as KWS signals, the data preparation module 360 generates a dataset that includes some samples of AED signals and some samples of KWS signals. The data preparation module 360 determines the ratio of the different types of signals based on various criteria.

The data preparation module 360 provides the training data 715 to the machine learning model 320 for training the machine learning model 320. For each sample of the training data 715, the machine learning model 320 is executed to output the scores. For example, if a sample represents AED signal, the machine learning model 320 outputs an AED score 725 and if the sample represents a KWS signal, the machine learning model 320 outputs a KWS score 735. The model training module 380 determines a loss L_{AED} 745 based on the AED score 725 generated by the machine learning model 320 for AED signals. The model training module 380 determines a loss L_{KWS} 755 based on the KWS score 725 generated by the machine learning model 320 for KWS signals. The loss for a type of signal represents a measure of a difference between a prediction made by the machine learning model 320 and the actual value of the output, for example, as determined from labelled data. The model training module 380 determines an aggregate loss L_{AGG} 765 as a weighted aggregate of the losses L_{AED} and L_{KWS}. For example, the aggregate loss L_{AGG}=α*L_{AED}+β*L_{KWS}, where α and β are constants that are adjusted based on various factors.

According to an embodiment, the model training module 380 adjusts the training dataset based on the loss values losses L_{AED} and L_{KWS}. For example, assume that the output O1 of the machine learning model corresponds to signals of type S1 (e.g., AED signals) and the output O2 of the machine learning model corresponds to signals of type S2 (e.g., KW signals). Further assume that loss L1 corresponds to output O1 and loss L2 corresponds to output O2. If the loss value L1 for output O1 is determined to be greater than the loss value L2 for the output O2 for a training dataset, the training dataset is adjusted to increase the size of the set of samples of signals of type S1 compared to samples of type S2. Alternatively, if the loss value L2 for output O2 is determined to be greater than the loss value L1 for the output O1 for a training dataset, the training dataset is adjusted to increase the size of the set of samples of signals of type S2 compared to samples of type S1. According to an embodiment, the training dataset is adjusted so that the ratio of the size of the set of samples of type S1 to the ratio of the size of the set of samples of size S2 is determined based on a ratio of the losses L1 to L2. For example, the training dataset may be adjusted so that the ratio of the size of the set of samples of type S1 to the ratio of the size of the set of samples of size S2 is directly proportional to the ratio of the losses L1 to L2.

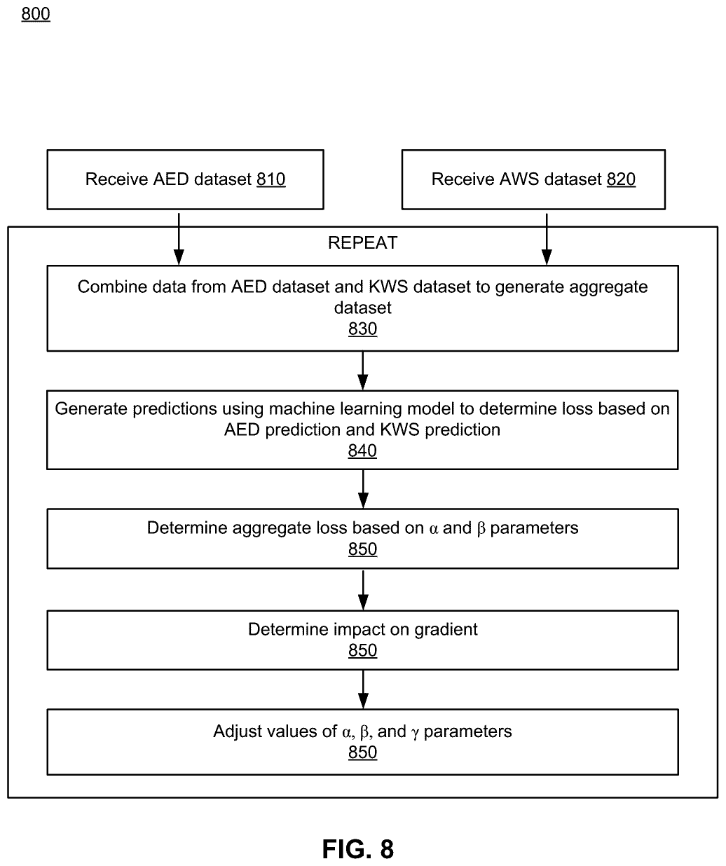

FIG. 8 is a flowchart of a process illustrating the training of the machine learning model, in accordance with one or more embodiments. The process shown in FIG. 8 may be performed by components of an audio system (e.g., audio system 200). Other entities may perform some or all of the steps in FIG. 8 in other embodiments. Embodiments may include different and/or additional steps, or perform the steps in different orders.

The model training module 380 receives 810 AED dataset comprising samples of AED signals. The model training module 380 receives 820 KWS dataset comprising samples of KWS signals. The data preparation module 360 combines 830 samples from the AED dataset and samples from the KWS dataset to generate an aggregate training dataset for the machine learning model 320. According to an embodiment, the data preparation module 360 determines a parameter γ that controls the ratio of the number of samples N_{AED} of the AED signals and the number N_{KWS} of samples of KWS signals in the training dataset. For example, if the total number of samples in the training dataset is N_{TOTAL}, then N_{AED}=γ*N_{TOTAL} and N_{KWS}=(1−γ)* N_{TOTAL}.

The model training module 380 determine a measure of loss L_{AED} based on the AED samples of the training dataset and a measure of loss L_{KWS} based on the KWS samples of the training dataset. The model training module 380 determines an aggregate measure of loss L_{AGG} as a combination of the measure of loss L_{AED} and the measure of loss L_{KWS}, for example, L_{AGG}=α*L_{AED}+β*L_{KWS}. The system further determines a change in the parameters of the model based on the gradient of the loss. The change in parameters may be determined for different subsets of parameters of the machine learning models across two iterations of the training, for example, the set of parameters for the AED prediction component 340 and the set of parameters for the KWS prediction component 350. The model training module 380 monitors the change in parameters for different components of the machine learning model across iterations of the training and adjusts the training dataset based on the changes in parameters across iterations of the training process.

The system adjusts the training dataset based on the measure of the impact of the training dataset on the gradient. According to an embodiment, the system trains the machine learning model using samples of a particular type of signal (e.g., AED signals) and determines an impact on the gradient of the parameters of the other component processing the other type of signals (e.g., KWS signals). If training of the machine learning model using samples of a particular type of signal (e.g., S1) causes more than a threshold change in the parameters of the other component (e.g., component making predictions for signal of type S1), the system adjusts the training dataset by reducing the number of samples of the signals of type S1 compared to samples of signals of type S2. For example, if training of the machine learning model using samples of AED signals causes more than a threshold change in the parameters of KWS prediction component 350, the system adjusts the training dataset by reducing the number of samples of the AED signals compared to KWS signals. Similarly, if training of the machine learning model using samples of KWS signals causes more than a threshold change in the parameters of AED prediction component 340, the system adjusts the training dataset by reducing the number of samples of the KWS signals compared to AED signals.

FIG. 9 is a system 900 that includes a headset 905, in accordance with one or more embodiments. In some embodiments, the headset 905 may be the headset 100 of FIG. 1. The system 900 may operate in an artificial reality environment (e.g., a virtual reality environment, an augmented reality environment, a mixed reality environment, or some combination thereof). The system 900 shown by FIG. 9 includes the headset 905, an input/output (I/O) interface 910 that is coupled to a console 915, the network 920, and the mapping server 925. While FIG. 9 shows an example system 900 including one headset 905 and one I/O interface 910, in other embodiments any number of these components may be included in the system 900. For example, there may be multiple headsets each having an associated I/O interface 910, with each headset and I/O interface 910 communicating with the console 915. In alternative configurations, different and/or additional components may be included in the system 900. Additionally, functionality described in conjunction with one or more of the components shown in FIG. 9 may be distributed among the components in a different manner than described in conjunction with FIG. 9 in some embodiments. For example, some or all of the functionality of the console 915 may be provided by the headset 905.

The headset 905 includes the display assembly 930, an optics block 935, one or more position sensors 940, and the DCA 945. Some embodiments of headset 905 have different components than those described in conjunction with FIG. 9. Additionally, the functionality provided by various components described in conjunction with FIG. 9 may be differently distributed among the components of the headset 905 in other embodiments, or be captured in separate assemblies remote from the headset 905.

The display assembly 930 displays content to the user in accordance with data received from the console 915. The display assembly 930 displays the content using one or more display elements (e.g., the display elements 120). A display element may be, e.g., an electronic display. In various embodiments, the display assembly 930 comprises a single display element or multiple display elements (e.g., a display for each eye of a user). Examples of an electronic display include: a liquid crystal display (LCD), an organic light emitting diode (OLED) display, an active-matrix organic light-emitting diode display (AMOLED), a waveguide display, some other display, or some combination thereof. Note in some embodiments, the display element 120 may also include some or all of the functionality of the optics block 935.

The optics block 935 may magnify image light received from the electronic display, corrects optical errors associated with the image light, and presents the corrected image light to one or both eye boxes of the headset 905. In various embodiments, the optics block 935 includes one or more optical elements. Example optical elements included in the optics block 935 include: an aperture, a Fresnel lens, a convex lens, a concave lens, a filter, a reflecting surface, or any other suitable optical element that affects image light. Moreover, the optics block 935 may include combinations of different optical elements. In some embodiments, one or more of the optical elements in the optics block 935 may have one or more coatings, such as partially reflective or anti-reflective coatings.

Magnification and focusing of the image light by the optics block 935 allows the electronic display to be physically smaller, weigh less, and consume less power than larger displays. Additionally, magnification may increase the field of view of the content presented by the electronic display. For example, the field of view of the displayed content is such that the displayed content is presented using almost all (e.g., approximately 110 degrees diagonal), and in some cases, all of the user's field of view. Additionally, in some embodiments, the amount of magnification may be adjusted by adding or removing optical elements.

In some embodiments, the optics block 935 may be designed to correct one or more types of optical error. Examples of optical error include barrel or pincushion distortion, longitudinal chromatic aberrations, or transverse chromatic aberrations. Other types of optical errors may further include spherical aberrations, chromatic aberrations, or errors due to the lens field curvature, astigmatisms, or any other type of optical error. In some embodiments, content provided to the electronic display for display is pre-distorted, and the optics block 935 corrects the distortion when it receives image light from the electronic display generated based on the content.

The position sensor 940 is an electronic device that generates data indicating a position of the headset 905. The position sensor 940 generates one or more measurement signals in response to motion of the headset 905. The position sensor 190 is an embodiment of the position sensor 940. Examples of a position sensor 940 include: one or more IMUs, one or more accelerometers, one or more gyroscopes, one or more magnetometers, another suitable type of sensor that detects motion, or some combination thereof. The position sensor 940 may include multiple accelerometers to measure translational motion (forward/back, up/down, left/right) and multiple gyroscopes to measure rotational motion (e.g., pitch, yaw, roll). In some embodiments, an IMU rapidly samples the measurement signals and calculates the estimated position of the headset 905 from the sampled data. For example, the IMU integrates the measurement signals received from the accelerometers over time to estimate a velocity vector and integrates the velocity vector over time to determine an estimated position of a reference point on the headset 905. The reference point is a point that may be used to describe the position of the headset 905. While the reference point may generally be defined as a point in space, however, in practice the reference point is defined as a point within the headset 905.

The DCA 945 generates depth information for a portion of the local area. The DCA includes one or more imaging devices and a DCA controller. The DCA 945 may also include an illuminator. Operation and structure of the DCA 945 is described above with regard to FIG. 1.

The audio system 950 provides audio content to a user of the headset 905. The audio system 950 is substantially the same as the audio system 200 describe above. The audio system 950 may comprise one or acoustic sensors, one or more transducers, and an audio controller. The audio system 950 may provide spatialized audio content to the user. In some embodiments, the audio system 950 may request acoustic parameters from the mapping server 925 over the network 920. The acoustic parameters describe one or more acoustic properties (e.g., room impulse response, a reverberation time, a reverberation level, etc.) of the local area. The audio system 950 may provide information describing at least a portion of the local area from e.g., the DCA 945 and/or location information for the headset 905 from the position sensor 940. The audio system 950 may generate one or more sound filters using one or more of the acoustic parameters received from the mapping server 925, and use the sound filters to provide audio content to the user.

The I/O interface 910 is a device that allows a user to send action requests and receive responses from the console 915. An action request is a request to perform a particular action. For example, an action request may be an instruction to start or end capture of image or video data, or an instruction to perform a particular action within an application. The I/O interface 910 may include one or more input devices. Example input devices include: a keyboard, a mouse, a game controller, or any other suitable device for receiving action requests and communicating the action requests to the console 915. An action request received by the I/O interface 910 is communicated to the console 915, which performs an action corresponding to the action request. In some embodiments, the I/O interface 910 includes an IMU that captures calibration data indicating an estimated position of the I/O interface 910 relative to an initial position of the I/O interface 910. In some embodiments, the I/O interface 910 may provide haptic feedback to the user in accordance with instructions received from the console 915. For example, haptic feedback is provided when an action request is received, or the console 915 communicates instructions to the I/O interface 910 causing the I/O interface 910 to generate haptic feedback when the console 915 performs an action.

The console 915 provides content to the headset 905 for processing in accordance with information received from one or more of: the DCA 945, the headset 905, and the I/O interface 910. In the example shown in FIG. 9, the console 915 includes an application store 955, a tracking module 960, and an engine 965. Some embodiments of the console 915 have different modules or components than those described in conjunction with FIG. 9. Similarly, the functions further described below may be distributed among components of the console 915 in a different manner than described in conjunction with FIG. 9. In some embodiments, the functionality discussed herein with respect to the console 915 may be implemented in the headset 905, or a remote system.

The application store 955 stores one or more applications for execution by the console 915. An application is a group of instructions, that when executed by a processor, generates content for presentation to the user. Content generated by an application may be in response to inputs received from the user via movement of the headset 905 or the I/O interface 910. Examples of applications include: gaming applications, conferencing applications, video playback applications, or other suitable applications.

The tracking module 960 tracks movements of the headset 905 or of the I/O interface 910 using information from the DCA 945, the one or more position sensors 940, or some combination thereof. For example, the tracking module 960 determines a position of a reference point of the headset 905 in a mapping of a local area based on information from the headset 905. The tracking module 960 may also determine positions of an object or virtual object. Additionally, in some embodiments, the tracking module 960 may use portions of data indicating a position of the headset 905 from the position sensor 940 as well as representations of the local area from the DCA 945 to predict a future location of the headset 905. The tracking module 960 provides the estimated or predicted future position of the headset 905 or the I/O interface 910 to the engine 965.

The engine 965 executes applications and receives position information, acceleration information, velocity information, predicted future positions, or some combination thereof, of the headset 905 from the tracking module 960. Based on the received information, the engine 965 determines content to provide to the headset 905 for presentation to the user. For example, if the received information indicates that the user has looked to the left, the engine 965 generates content for the headset 905 that mirrors the user's movement in a virtual local area or in a local area augmenting the local area with additional content. Additionally, the engine 965 performs an action within an application executing on the console 915 in response to an action request received from the I/O interface 910 and provides feedback to the user that the action was performed. The provided feedback may be visual or audible feedback via the headset 905 or haptic feedback via the I/O interface 910.

The network 920 couples the headset 905 and/or the console 915 to the mapping server 925. The network 920 may include any combination of local area and/or wide area networks using both wireless and/or wired communication systems. For example, the network 920 may include the Internet, as well as mobile telephone networks. In one embodiment, the network 920 uses standard communications technologies and/or protocols. Hence, the network 920 may include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 920 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 920 can be represented using technologies and/or formats including image data in binary form (e.g. Portable Network Graphics (PNG)), hypertext markup language (HTML), extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc.

The mapping server 925 may include a database that stores a virtual model describing a plurality of spaces, wherein one location in the virtual model corresponds to a current configuration of a local area of the headset 905. The mapping server 925 receives, from the headset 905 via the network 920, information describing at least a portion of the local area and/or location information for the local area. The user may adjust privacy settings to allow or prevent the headset 905 from transmitting information to the mapping server 925. The mapping server 925 determines, based on the received information and/or location information, a location in the virtual model that is associated with the local area of the headset 905. The mapping server 925 determines (e.g., retrieves) one or more acoustic parameters associated with the local area, based in part on the determined location in the virtual model and any acoustic parameters associated with the determined location. The mapping server 925 may transmit the location of the local area and any values of acoustic parameters associated with the local area to the headset 905.

One or more components of system 900 may contain a privacy module that stores one or more privacy settings for user data elements. The user data elements describe the user or the headset 905. For example, the user data elements may describe a physical characteristic of the user, an action performed by the user, a location of the user of the headset 905, a location of the headset 905, an HRTF for the user, etc. Privacy settings (or “access settings”) for a user data element may be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some embodiments, the privacy settings for a user data element may specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user of a headset within the same local area as the user. If the user subsequently changes location, the entity with access to the user data element may lose access, while a new group of entities may gain access as they come within the threshold distance of the user.

The system 900 may include one or more authorization/privacy servers for enforcing privacy settings. A request from an entity for a particular user data element may identify the entity associated with the request and the user data element may be sent only to the entity if the authorization server determines that the entity is authorized to access the user data element based on the privacy settings associated with the user data element. If the requesting entity is not authorized to access the user data element, the authorization server may prevent the requested user data element from being retrieved or may prevent the requested user data element from being sent to the entity. Although this disclosure describes enforcing privacy settings in a particular manner, this disclosure contemplates enforcing privacy settings in any suitable manner.

### Voice Verification for Hands Free Authentication of Smart Glasses

Voice Verification is used to determine whether an audio matches a particular person's voice. The system uses a voice profile collected from an enrolled user, to measure a variety of characteristics of the user's voice. Subsequently the profile is compared to the audio from a voice command to verify if the user providing the voice command is the same person that enrolled with the voice profile. According to an embodiment, all processing is on-device and the voice profile is only saved on device.

User authentication is significant for smart glasses to ensure user security (prevent any unauthorized use) and privacy (prevent harm) when sharing private data with family and friends. A system may send a push notification to user's phone pending an authentication whenever an attempt is made to access sensitive information through voice assistant. This authentication session expires after a certain time window and may require a subsequent phone authentication. Such phone-based authentication may cause user friction through frequent push notifications on smart phone while wearing the smart glass.

The system as disclosed uses voice verification as an authentication approach. There are two parts of voice verification-enrollment and runtime. Enrollment is the process of user using their companion application to enroll a voice profile by saying some predefined sentences. This voice profile is stored on the device and used for verifying the current speaker at runtime, i.e., whenever voice assistant got triggered. This approach provides a hands-free experience to smart glass users without the need to constantly authenticate using their phone and is a general approach that can be applied to various devices such as VR (virtual reality) headsets (e.g., Oculus™).

The system may apply voice verification in three possible scenarios: (1) Side Speech: Reducing voice assistant false triggers from people near the device; 2) Intentional Misuse: an unauthorized user using the smart glasses and saying a command; (3) Wake-word-less Interaction: i.e., user giving commands without providing the wake-word, for example, by saying ‘Hey Facebook’. Voice verification helps filter out the background speech.

The system has three main components, user interface component, voice enrollment component, and voice verification component. According to other embodiments, the system may have more or fewer components. Functionality indicated as being performed by a particular component may be performed by other components.

User interface component may execute on smart glasses' companion application. This allows users to enable/disable the voice verification feature. For first-time enabled users, the application prompts users to enter voice enrollment flow. This requires users to speak a few predefined sentences, to build their voice profile for performing voice enrollment.

Voice verification can be set up while using the companion app. A GUI (graphical user interface) flow prompts the user to record utterances for enrollment by showing a phrase on the screen which the user repeats back.

According to an embodiment, the user wears their glasses when performing voice enrollment or verification. The phrases are recorded using the glasses microphones instead of using the phone. The system accuracy increases with more enrollment utterances. The user may be asked to say phrases shown in the app multiple times, for example, up to 4 times.

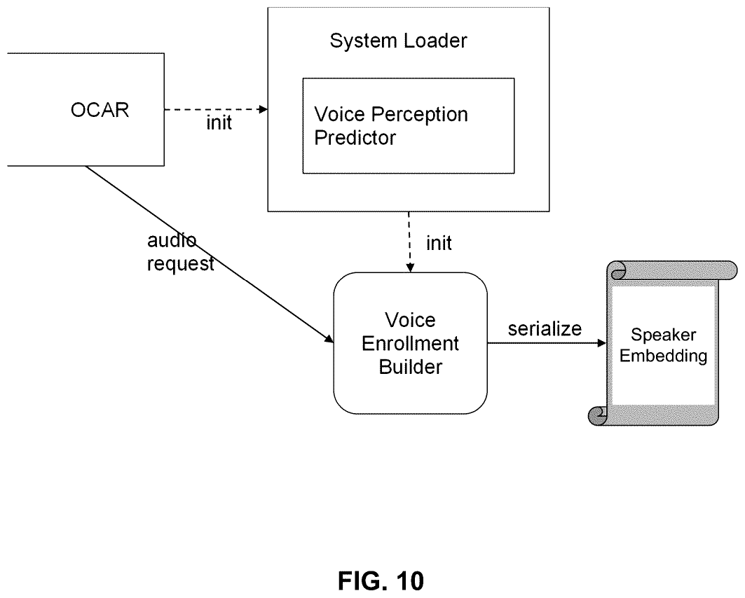

FIG. 10 illustrates the interaction between various components for voice enrollment, according to an embodiment.

The voice enrollment component processes voice enrollment requests. Once a voice enrollment request is routed to OACR (on-device assistant client runtime) component from the device, the assistant handles such request without the need of ASR (automatic speech recognition). The system may perform speaker embedding generation for each audio request and serialize the speaker embedding locally on device.

For voice enrollment, a new path may be established in parallel to ASR requests. A speech team offers a shared library (Voice Perception Predictor), which is used to generate speaker embedding from audio. This shared library may be wrapped into the system loader.

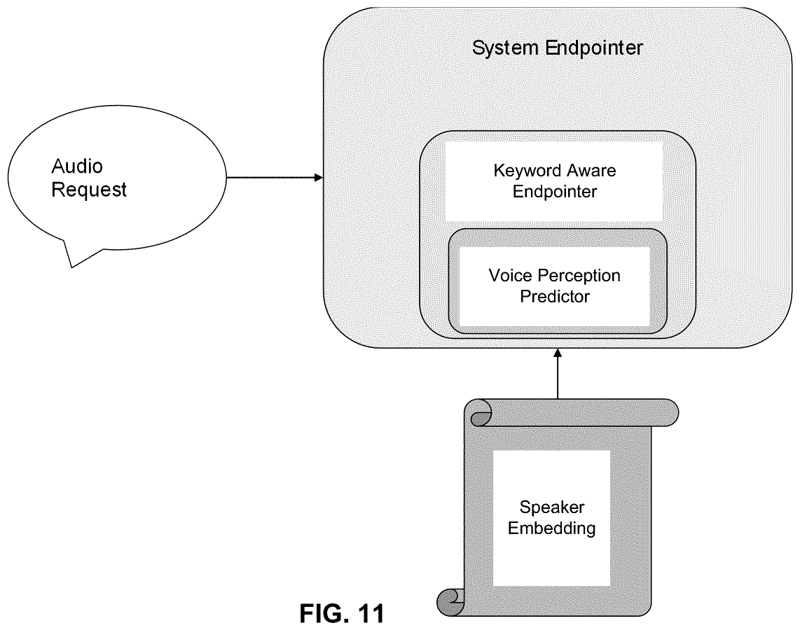

FIG. 11 illustrates the interaction between various components for voice verification, according to an embodiment.

The voice verification component performs voice verification at runtime. During ASR runtime, voice verification is part of the systems keyword aware end pointer module, which checks multiple conditions to decide whether an ASR request will be terminated early, including second stage wake word verification, audio fingerprinting, and so on. The system may use the locally stored speaker embeddings as user profile and reject ASR requests if the on-going audio does not match the profile.

For voice verification, the system may rely on keyword aware end pointer to mark intermediate ASR results, to determine whether an ASR request needs to be terminated earlier. The system loads the needed model for voice verification and deserializes the speaker profiles based on model configuration.

### Adaptive Curation Learner Using Dynamically Placed Adaptive Anchors

An adaptive curation learner (ACL) can be used by an AR or MR system to predict object locations based on room geometries (e.g., for presentation to a user via a headset 905). The ACL may be implemented on, e.g., one or more computers. The ACL may be trained to predict locations to be associated with virtual objects based on room configuration. Room configuration describes how a particular room is configured. Room configuration may be described using, e.g., room size, room use, furniture in the room, objects in the room, structural details (e.g., number of doors, closets, etc.), room lighting, wall coverings (e.g., wallpaper, art, murals, etc.), end-user age range, some other feature that describes the room, or some combination thereof.

In various embodiments, a user (e.g., artificial reality content creator, advertiser, etc.) of the ACL creates assets (e.g., virtual objects for a game, virtual advertisements, etc.) and their interrelated logic. The ACL can then be used to dynamically place adaptive anchors (may also be referred to as dynamic anchors) in various room configurations without the input of the user. In this manner, e.g., the ACL may be used to assist artificial reality content developers (e.g., MR content developers) to create an ML-based Scene Curation Model (SCM) for each experience module allowing virtual assets to automatically adapt to diverse layouts in target spaces.

The ACL uses a scene curation model (model) to place adaptive anchors. The model is trained to predict a location to be associated with one or more virtual objects given a specific room configuration. In some embodiments, the ACL selects a plurality of room configurations that are each different from each other. For example, the ACL may select room configurations that commonly correspond to a bedroom. Alternatively, the ACL may select one or more room configurations that correspond to different room uses (e.g., one or more of a bedroom, one or more of a living room, etc.). In some embodiments, the ACL may randomly or pseudo-randomly generate the plurality of room configurations. In some embodiments, the user may provide some inputs to guide the room configuration selection (e.g., room use, end user age range, etc.). For example, the user may want to train the model for room configurations that are generally associated with people in their 20s. In other embodiments, the user may select the room plurality of room configurations. In some embodiments, a total number of room configurations for the ACL to be trained on may be relatively small (e.g., 15-20 different room configurations). In other embodiments, the total number of room configurations may be larger or smaller.

The ACL provides the plurality of room configurations for presentation to the user. In some embodiments, the ACL may sequentially provide the plurality of room configuration, where it waits to provide the next room configuration until it has received user input (e.g., location of an adaptive anchor). The ACL may, e.g., instruct a user interface presented on a user device (e.g., desktop computer, laptop, tablet, etc.) to present one or more of the plurality of room configurations.

For each presented room configuration, the ACL receives from the user device a corresponding training location for an adaptive anchor. The adaptive anchor may be associated with a virtual object. For example, the adaptive anchor may be a location for virtual object (e.g., virtual dragon, an advertisement), an application interface, one or more positions of the virtual object as a function of time, etc.

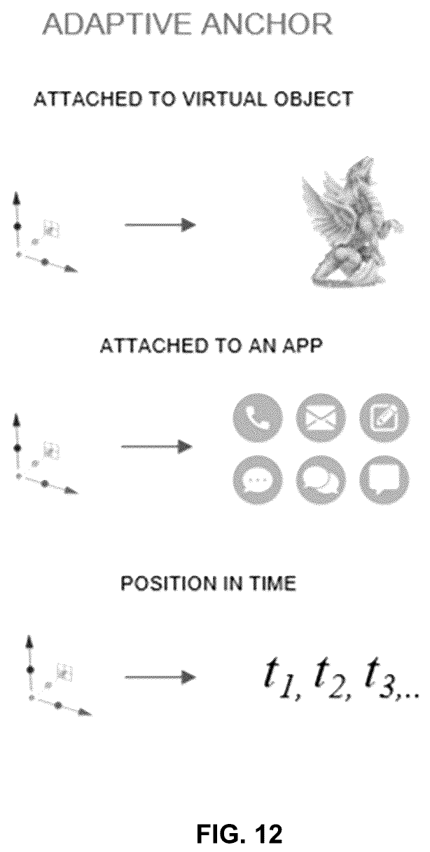

FIG. 12 illustrates example embodiments of an adaptive anchor. As illustrated, an adaptive anchor is an origin for a coordinate space that can be attached to various other things, such as one or more of a virtual object, an application (e.g., a phone, text, or email app), or a point in time. The model is trained to predict for a given room configuration a corresponding location of an adaptive anchor using the plurality of room configurations and the corresponding training locations. Note in some embodiments, the model has no knowledge of what the adaptive anchor is actually associated with (e.g., does not know that the virtual object is a virtual dragon). The model may represent room configurations using scene graph representation (explicit learning or implicit learning), where nodes in the graph are associated with different objects.

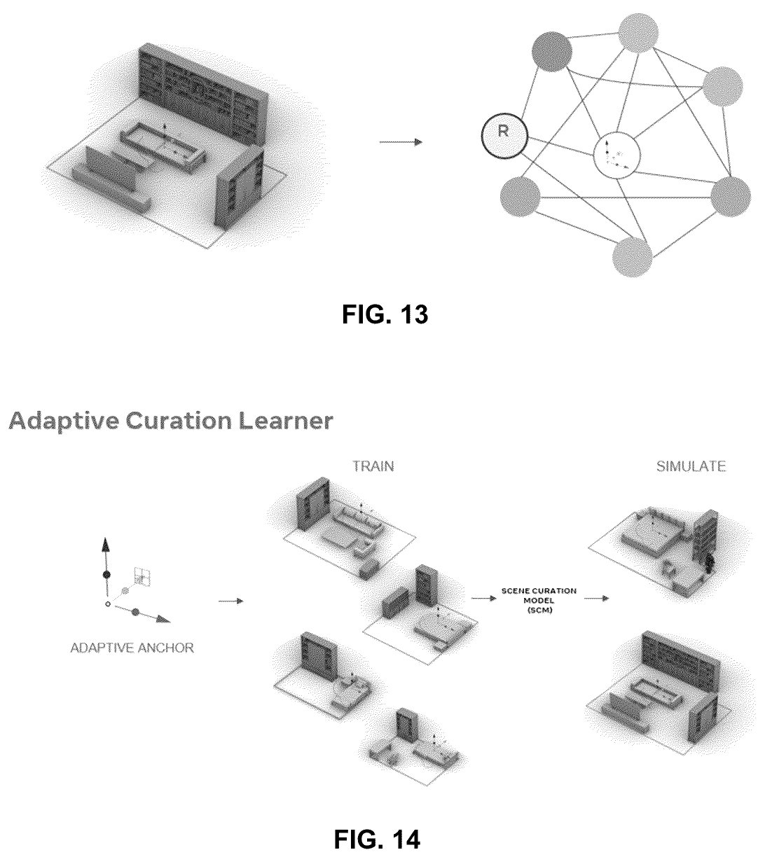

FIG. 13 illustrates one embodiment of a scene graph representing a particular room configuration. In the illustrated embodiment, explicit learning is used for the scene graph representation. In this case the ACL defines relationships (edges) between nodes. The relationships may describe, e.g., location, orientation, etc., of a particular node relative other nodes. One advantage of this embodiment, is that the user may selectively which relationships are active/inactive to, e.g., focus on particular nodes. In other embodiments, implicit learning is used for the scene graph representation. In this case, the model may be, e.g., a neural network. Example edges in one embodiment represent relationships such as whether objects represented by nodes are facing each other, colliding with each other, close together, stacked one on top of the other, or have a relationship where one is centered or corner-aligned to another, etc.

Using explicit learning for the ACL may enable the developer to interpret the model and enable or disable features. However, this may come at the cost of heuristics causing biased learning and failure to capture all relationships in a particular room configuration. In contrast, use of implicit learning may enable the capture of topologies without a name and unbiased heuristics, but can come at the cost of requiring a greater number of data points and the inability of the developer to interpret the output of the model.

Once the model is trained, the user (e.g., developer, advertiser, etc.) may use the ACL to predict adaptive anchor locations for any room configuration. And in some embodiments, the model may be integrated into the artificial reality product. In this manner, the ACL may enhance functionality of an artificial reality product as it could, for any room configuration, select a location of an adaptive anchor in a manner of the user′ (e.g., developer)—even though the user may not have ever seen the particular room configuration.

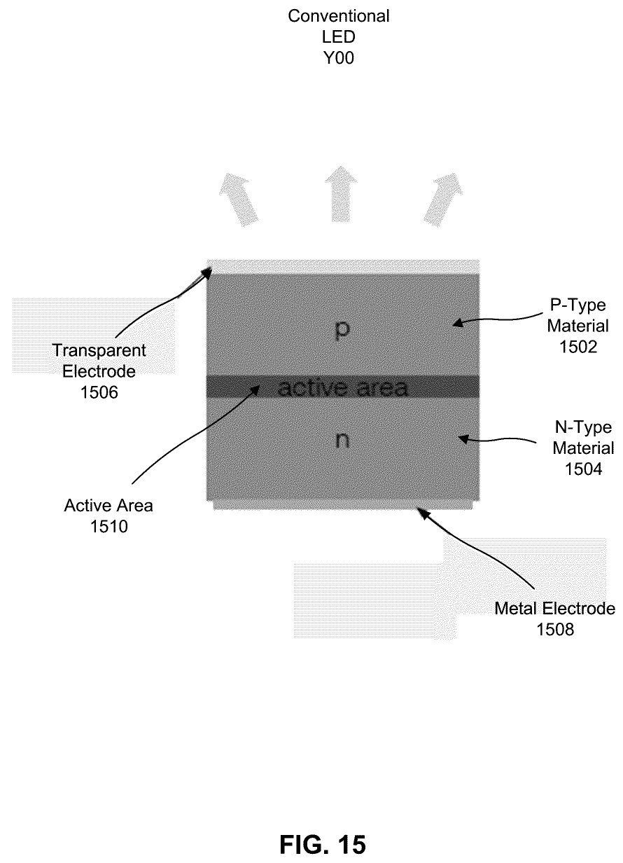

FIG. 14 illustrates one embodiment of a process flow for training a model that uses a scene graph that nay be used to determine placement of adaptive anchors. In contrast, conventional systems tend to be rule based (e.g., procedural modeling) which to be thorough can be quite complicated. Procedural models are often limited to a number of layout scenarios, hence developers may not be able to generalize their experiences to all target spaces. To simplify, they may opt to use minimum semantic requirements for the design of the experiences to maximize their audience. However, this itself can slow down the adoption of object-level semantics for artificial reality applications.

Note while the ACL is largely described in the context of providing a tool for artificial reality developers (e.g., MR developers). In some embodiments, it may be used for other applications. For example, the ACL may be used by advertisers to determine locations for advertisements to be placed in rooms regardless of room configuration. There is no minimum or maximum value for number of sample scenes presented by the ACL for training. The ACL can provide object placement with 0 scenes (often called as Zero-shot learning) by using information other than the Adaptive Anchor provided by the user.

Embodiments of the ACL may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

Improved LED Structure with N-Metal Electrode on Light-Emitting Side

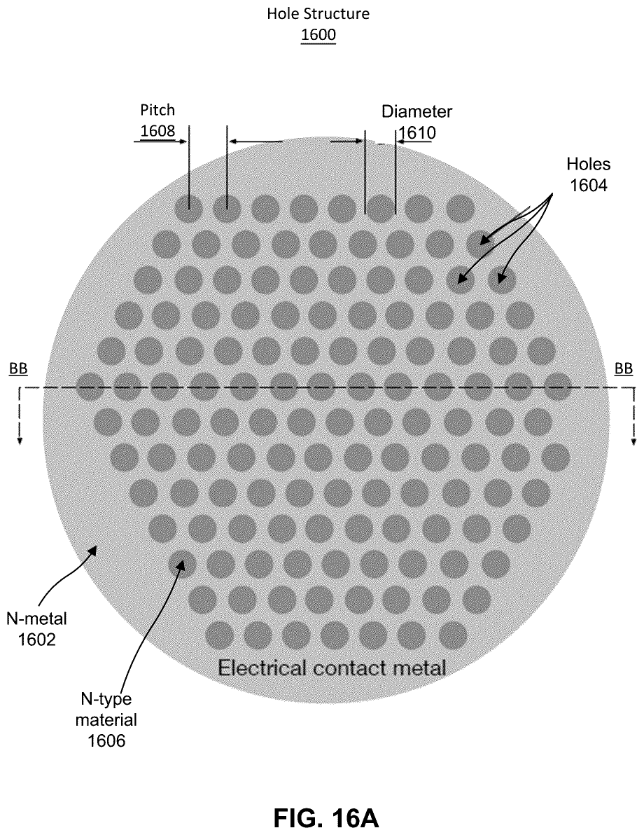

FIG. 15 illustrates a conventional LED structure, according to an example embodiment. In the conventional LED 1500 illustrated in FIG. Y, a p-type material 1502 (e.g., a p-doped semiconductor) and a n-type material 1504 abut one another in the LED. A transparent electrode 1506 is on a top surface of the LED, and a metal electrode 1508 is on the bottom surface of the LED 1500. An active area 1510 is created where the p-type material and n-type material meet in the LED. The metal electrode and the transparent electrode are used to bias the LED and create carriers. As carriers in the p-type material and n-type material recombine in the active area, light is emitted. Generally, light is emitted through the transparent electrode.

As time has passed, various conventional LED structures have been shown to have many limitations. To that end, a novel Micro-LED structure was developed to overcome many of those limitations.

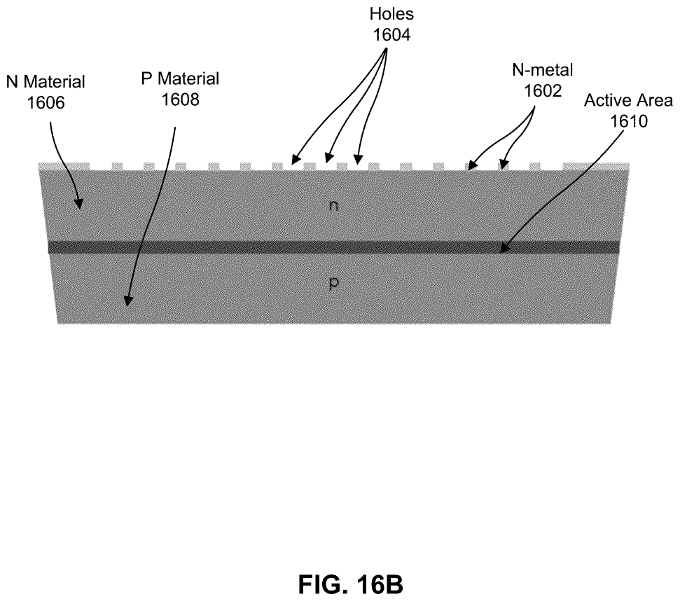

FIG. 16A illustrates a top view of first example of a micro-LED with current confining structures on a top surface, according to one example embodiment. In this example, the so-called hole-structure 1600, the n metal 1602 is patterned with an array of holes 1604. The holes allow light to pass from the n type material 1606 out through the holes 1604. The holes also serve to produce current confinement form the n metal when biasing the structure.

As illustrated, the holes are arrayed in a hexagonal pattern. Each hole may have the same diameter 1610 or a different diameter. As an example, the diameter may be less than a nanometer or several microns. Similarly, the array of holes may have a regular pitch 1608 (e.g., periodic) or an irregular pitch (e.g., non-periodic). As an example, the pitch of the holes may be around 10 nm, but could be up to several microns. Additionally, while the holes are pictured as circles, they may take some other form such as a square, ellipse, or triangle. The n material can be GaN, GaAs, InP, Si, etc. The n metal electrodes can be Al, Au, Ag, Ni, Zn, Ge, W, Pd, Pt, Ti, TCO or alloys, etc.

FIG. 16B illustrates a cross section view of the LED of FIG. 16A along the line BB, according to one example embodiment. In this cross-sectional view of the hole structure 1600, the n metal 1602 is patterned with holes 1604 (which appear as openings on the top surface). The n material 1606 abuts the p material 1608 and creates an active area 1610. When appropriately biased, light is emitted from the active area 1610 and through the holes 1604. The holes also aid in current confinement when biasing to create light.

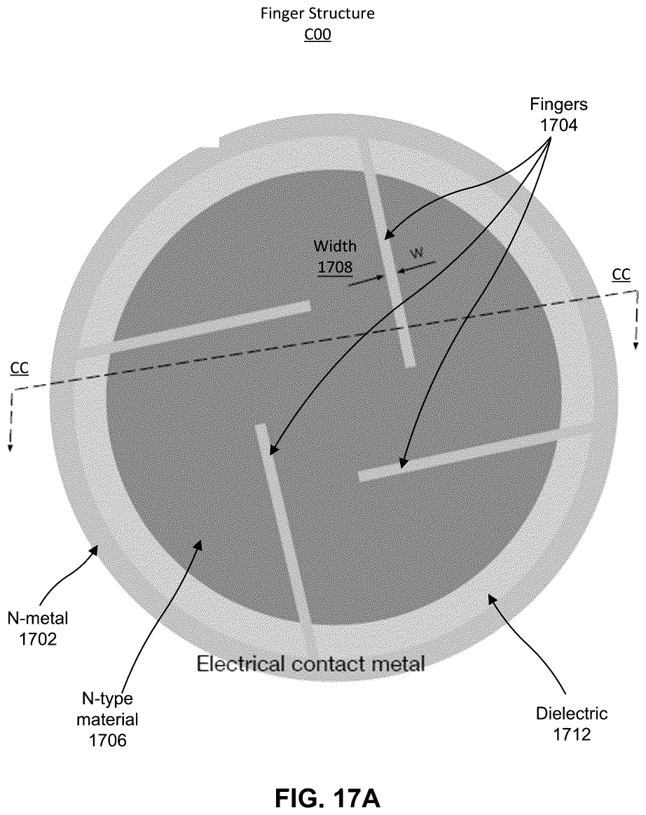

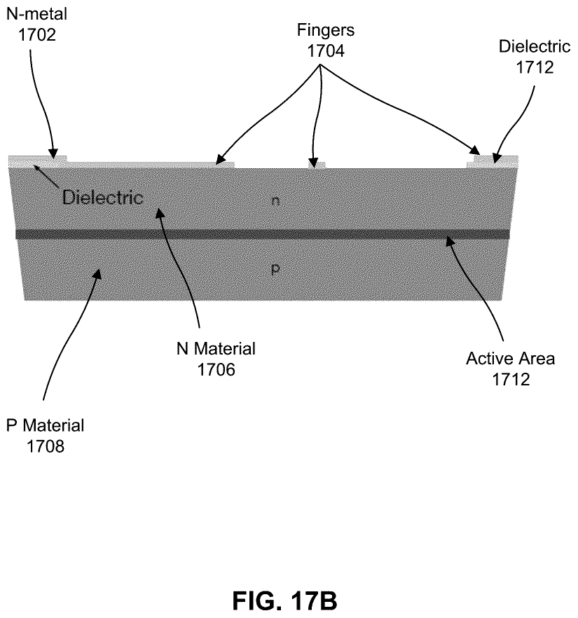

FIG. 17A illustrates a top view of second example of a micro-LED with current confining structures on a top surface, according to one example embodiment. In this example, the so-called finger-structure 1700, the n metal 1702 is patterned with an array of fingers 1704. The n metal 1704 may be isolated from the n material 1706 by a dielectric 1712. The fingers allow light to pass from the n type material 1706 and out through the fingers 1704. The fingers also serve to produce current confinement form the n metal when biasing the structure.

As illustrated, the fingers are arrayed in a regular pattern. Each finger may have the same width 1708 or a different width. As an example, the width may be less than a nanometer or several microns. Similarly, the array of fingers may have a regular pattern or an irregular pattern. Additionally, while the fingers are pictured as straight rectangular structure, they may take some other form factor. The n material can be GaN, GaAs, InP, Si, etc. The n metal electrodes can be Al, Au, Ag, Ni, Zn, Ge, W, Pd, Pt, Ti, TCO or alloys, etc.

FIG. 17B illustrates a cross section view of the LED of FIG. 17A along the line CC, according to one example embodiment. In this cross-sectional view of the finger structure 1700, the n metal 1702 is patterned with fingers 1704 (which appear as lines of n metal on the top surface). The n material 1706 abuts the p material 1708 and creates an active area 1710. When appropriately biased, light is emitted from the active area 1710 and through the fingers 1704. The fingers also aid in current confinement when biasing to create light.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer program product comprising a non-transitory computer-readable storage medium containing computer program code that comprises instructions that when executed by one or more processors, cause the one or more processors to perform steps comprising:
receiving, by an audio sensor of a device, an audio stream; and
repeating:
extracting a candidate signal from the audio stream;
receiving an indication of whether the candidate signal represents an acoustic event or a keyword;
providing the candidate signal as input to a machine learning model trained to predict a first output representing a classification of acoustic events and a second output representing a classification of the keyword;
responsive to receiving the indication that the candidate signal represents an acoustic event, classifying the candidate signal based on the first output to determine a type of the acoustic event and performing an action based on the type of the acoustic event; and
responsive to determining that the candidate signal represents a keyword, classifying the candidate signal based on the second output, and determining whether to activate one or more components of the device based on the classification.

2. The computer program product of claim 1, wherein an acoustic event corresponds to a sound generated by one or more sources that are at least a threshold distance from the audio sensor, and the keyword corresponds to a sound generated by a source within the threshold distance from the audio sensor.

3. The computer program product of claim 1, wherein a first candidate signal representing an acoustic signal is longer than a second candidate signal representing a keyword.

4. The computer program product of claim 1, wherein the instructions cause the one or more processors to perform steps comprising:
generating a training dataset for training the machine learning model, the training dataset comprising a first set of samples representing acoustic events and a second set of samples representing the keyword; and
adjusting a ratio of a number of samples in the first set of samples to a number of samples in the second set of samples during training of the machine learning model.

5. The computer program product of claim 4, wherein the ratio of the number of samples in the first set of samples to the number of samples in the second set of samples is determined based on a loss corresponding to the first output and a loss corresponding to the second output.

6. The computer program product of claim 4, wherein the ratio of the number of samples in the first set of samples to the number of samples in the second set of samples is determined based on a measure of change in gradient of parameters of the machine learning model during training.

7. The computer program product of claim 1, wherein the machine learning model comprises a shared encoder, an acoustic event prediction component, and a keyword prediction component, wherein the shared encoder receives an input and generates an output provided as input to both the acoustic event prediction component and the keyword prediction component.

8. A computer-implemented method comprising:
receiving, by an audio sensor of a device, an audio stream; and
repeating:
extracting a candidate signal from the audio stream;
receiving an indication of whether the candidate signal represents an acoustic event or a keyword;
providing the candidate signal as input to a machine learning model trained to predict a first output representing a classification of acoustic events and a second output representing a classification of the keyword;
responsive to receiving the indication that the candidate signal represents an acoustic event, classifying the candidate signal based on the first output to determine a type of the acoustic event and performing an action based on the type of the acoustic event; and
responsive to determining that the candidate signal represents a keyword, classifying the candidate signal based on the second output, and determining whether to activate one or more components of the device based on the classification.

9. The computer-implemented method of claim 8, wherein an acoustic event corresponds to a sound generated by one or more sources that are at least a threshold distance from the audio sensor, and the keyword corresponds to a sound generated by a source within the threshold distance from the audio sensor.

10. The computer-implemented method of claim 8, wherein a first candidate signal representing an acoustic signal is longer than a second candidate signal representing a keyword.

11. The computer-implemented method of claim 8, further comprising:
generating a training dataset for training the machine learning model, the training dataset comprising a first set of samples representing acoustic events and a second set of samples representing the keyword; and
adjusting a ratio of a number of samples in the first set of samples to a number of samples in the second set of samples during training of the machine learning model.

12. The computer-implemented method of claim 11, wherein the ratio of the number of samples in the first set of samples to the number of samples in the second set of samples is determined based on a loss corresponding to the first output and a loss corresponding to the second output.

13. The computer-implemented method of claim 11, wherein the ratio of the number of samples in the first set of samples to the number of samples in the second set of samples is determined based on a measure of change in gradient of parameters of the machine learning model during training.

14. The computer-implemented method of claim 8, wherein the machine learning model comprises a shared encoder, an acoustic event prediction component, and a keyword prediction component, wherein the shared encoder receives an input and generates an output provided as input to both the acoustic event prediction component and the keyword prediction component.

15. A computer system comprising:
one or more computer processors; and
a non-transitory computer-readable storage medium containing computer program code that comprises instructions that when executed by one or more processors, cause the one or more processors to perform steps comprising:
receiving, by an audio sensor of a device, an audio stream; and
repeating:
extracting a candidate signal from the audio stream;
receiving an indication of whether the candidate signal represents an acoustic event or a keyword;
providing the candidate signal as input to a machine learning model trained to predict a first output representing a classification of acoustic events and a second output representing a classification of the keyword;
responsive to receiving the indication that the candidate signal represents an acoustic event, classifying the candidate signal based on the first output to determine a type of the acoustic event and performing an action based on the type of the acoustic event; and
responsive to determining that the candidate signal represents a keyword, classifying the candidate signal based on the second output, and determining whether to activate one or more components of the device based on the classification.

16. The computer system of claim 15, wherein an acoustic event corresponds to a sound generated by one or more sources that are at least a threshold distance from the audio sensor, and the keyword corresponds to a sound generated by a source within the threshold distance from the audio sensor.

17. The computer system of claim 15, wherein the instructions cause the one or more processors to perform steps comprising:
generating a training dataset for training the machine learning model, the training dataset comprising a first set of samples representing acoustic events and a second set of samples representing the keyword; and
adjusting a ratio of a number of samples in the first set of samples to a number of samples in the second set of samples during training of the machine learning model.

18. The computer system of claim 17, wherein the ratio of the number of samples in the first set of samples to the number of samples in the second set of samples is determined based on a loss corresponding to the first output and a loss corresponding to the second output.

19. The computer system of claim 17, wherein the ratio of the number of samples in the first set of samples to the number of samples in the second set of samples is determined based on a measure of change in gradient of parameters of the machine learning model during training.

20. The computer system of claim 15, wherein the machine learning model comprises a shared encoder, an acoustic event prediction component, and a keyword prediction component, wherein the shared encoder receives an input and generates an output provided as input to both the acoustic event prediction component and the keyword prediction component.
